(19) United States
(12) Patent Application Publication
(10) Pub. No.: US 2010/0024270 A1
(43) Pub. Date: Feb. 4, 2010

(54) DEVICE FOR DISPLAYING SIGNAGE, SUCH AS IN PARTICULAR ADVERTISING SHEET OR THE LIKE, ON SHELVING IN A SALES AREA

(75) Inventors: Manuel Alves, Tortosendo (PT); Pedro Dinis, Tortosendo (PT); Rosa Caseiro, Fundao (PT)

Correspondence Address: EGBERT LAW OFFICES, 412 MAIN STREET, 7TH FLOOR, HOUSTON, TX, 77002, US

(73) Assignee: JOALPE INDUSTRIA DE EXPOSITORES S.A., Tortosendo (PT)

(21) Appl. No.: 12/439,673

(22) PCT Filed: Aug. 21, 2007
(86) PCT No.: PCT/EP07/07353

§ 371 Date: Jul. 20, 2009

(30) Foreign Application Priority Data
Sep. 5, 2006 (FR) 06/07778

(51) Int. Cl. G09F 3/20; B29C 45/00

(52) U.S. Cl. 40/658; 40/642.02; 264/328.1

(57) ABSTRACT

The invention relates to a device for the display of a tagging item, such as in particular an advertising leaflet, or the like, on a shelf of a selling surface. The device exhibits the tagging item vertically, the latter protruding notably externally and at right angle from the front of the shelf. The device has at least one supporting wing-whereof the lower end includes an assembly on the proximal section of the shelf. The supporting wing has a holder for the tagging item, in particular by one of its edges. According to the invention, the holder exhibits the tagging item according to two different orientations relative to the supporting wing. The supporting wing has two bearing surfaces for the tagging item.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The invention relates to a device for the display of a tagging item, such as in particular an advertising leaflet or the like, on a shelf of a selling surface.

2. Description of Related Art Including Information Disclosed Under 37 CFR 1.97 and 37 CFR 1.98.

In order to draw the consumers' attention to specific items, it is known to arrange a tagging item protruding at a right angle, vertically on the front of the shelf.

Such tagging items enable in particular to put in evidence reductions and other promotional operations on certain articles while facilitating the localization of the latter on the shelf.

As known, the tagging item is carried by a presentation device, generally formed by a plastic supporting wing, designated as “shark wing”, exhibiting on its lower portion a mounting foot for the attachment of the device to the proximal section of the shelf.

This device holds the tagging item, generally by means of a set of a set of tongues and toes cooperating with corresponding orifices of the tagging item.

In selling premises, two types of shelves are typically encountered, those whereof the trays are horizontal and those whereof the trays are tilted, in particular forwards, usually a 30° angle relative to the horizontal.

Most devices known are designed only for shelves fitted with horizontal trays, wherein the tagging item to be exhibited is tilted, and hence hardly legible, when these devices are mounted on shelves with tilted trays.

Document FR-2.851.363 discloses a presentation device of tiltable tags, formed of a supporting wing and a section for assembly to the shelf. In order to suit the different possible tilting angles of the shelves, this device exhibits, moreover, a pivoting articulation between the supporting wing and the assembly section, enabling to arrange the tagging item according to the angle required. This device is thus formed of at least two elements, hinged one to another with a pivoting movement.

The aim of the present invention is to provide an alternative to this device for the display of tags, meeting the same objective problem, enabling to exhibit correctly a tagging item on two shelves a different tilting angle.

Another aim of the present invention is to provide a device for the display of a tagging item, at a lesser cost relative to a articulated device.

Other aims and advantages of the present invention will appear in the following description, which is given solely for illustrative purposes and without being limited thereto.

### BRIEF SUMMARY OF THE INVENTION

The invention relates to a device for the display of a tagging item, such as in particular an advertising leaflet or the like, on a shelf of a selling surface, the device being provided for exhibiting said tagging item vertically, the latter protruding notably externally and at a right angle from the front of the shelf. The device exhibits at least one supporting wing whereof the lower end includes means for assembly on the proximal section of the shelf, said supporting wing exhibiting means for holding the tagging item, in particular by one of its edges. The holding means exhibit the tagging item according to two different orientations relative to the supporting wing, said supporting wing exhibiting two bearing surfaces for said tagging item.

### BRIEF DESCRIPTION OF THE SEVERAL VIEWS OF THE DRAWINGS

The invention will be understood better when reading the following description, accompanied by the appended drawings, which are integral thereto.

FIG. 1 is a ¾ perspective view of a device for the display of a tagging item according to the invention.

FIG. 2 is a front elevation view of the device as illustrated on FIG. 1.

FIGS. 3 and 4 are respectively side elevation views of a shelf with horizontal trays and a shelf with tilted trays.

FIG. 5 is a left-hand side elevation view of the device as illustrated on FIG. 1, and more particularly enabling to hold a tag on a shelf with horizontal trays.

FIG. 6 is a right-hand side elevation view of the device as illustrated on FIG. 1, and more particularly the means for holding a tag on a shelf with tilted trays.

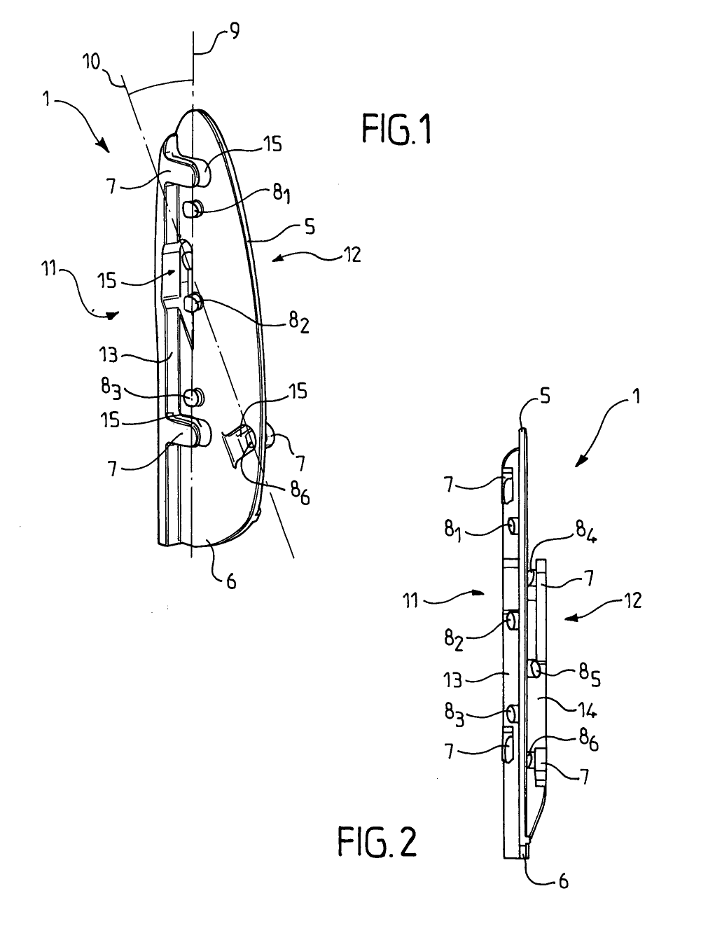

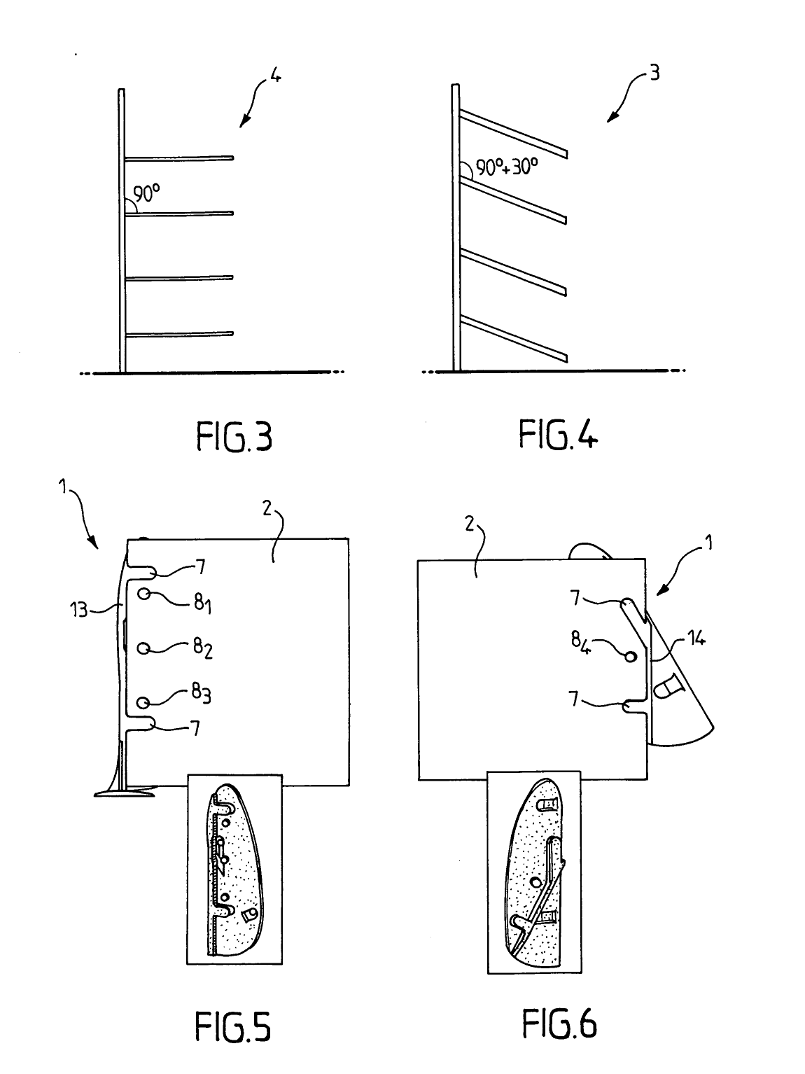

### DETAILED DESCRIPTION OF THE INVENTION

The invention relates to a device 1 for the display of a tagging item 2, such as in particular an advertising leaflet, or sign-board, or tag or the like, on a shelf 3, 4 of a selling surface.

The device 1 is provided for exhibiting the tagging item 2 vertically. The tagging item is protruding notably externally and at right angle from the front of the shelf 3, 4.

The device 1 exhibits at least one supporting wing 5 whereof the lower end 6 includes means for assembly (not illustrated) on the proximal section of the shelf. These mounting means may in particular consist of:
a fastening jumper capable of engaging with a rail arranged on the front edge of the shelf,
a fastening foot co-operating with drillings in the shelf, and
a nestable portion on a tag holder-type profile attached to the front edge of the shelf.

Said supporting wing 5 exhibits means for holding the tagging item, in particular by one of its edges. These holding means consist in particular of a set of a set of tongues 7 and toes 8 provided for engaging with corresponding orifices of the tagging item.

According to the invention, said holding means enable to exhibit the tagging item according to two different orientations 9, 10, relative to the supporting wing 5, said supporting wing 5 exhibiting two bearing surfaces 11, 13 for the tagging item.

In particular, the tongues 7 may extend parallel to the plane of the supporting wing 5 to define two insertion spaces, run through by said toes 8, in order to insert said tagging item.

In particular, said bearing surfaces are equipped respectively with said tongues enabling to delineate both insertion spaces.

Advantageously each insertion space enables to tilt the tagging item according to a given orientation relative to the supporting wing.

To do so, both insertion spaces and/or both bearing surfaces 10, 11 may be fitted respectively with a first row of toes 81, 82, 83 and a second row of toes 84, 85, 86, said second row of toes being tilted relative to said first row.

According to another instance, said means for holding the tagging item may be fitted with wedging rims 13, 14 capable of cooperating with the ridge of a tagging item. In particular, both bearing surfaces 11, 12 or still both insertion spaces, may be fitted respectively with a first wedging rim 13 and with a second wedging rim 14, said second rim 14 being tilted relative to said first rim 13.

As illustrated on the figures, said tongues 7 may extend physically from said wedging rims 13, 14. The toes 8 may protrude inside said insertion spaces, either from said bearing surfaces, or from the tongues 7, or still be distributed from the bearing surfaces and the tongues in each insertion space.

According to the embodiment illustrated on the figures, the supporting wing 5 consists of a transparent plastic material, of the order of 9 cm in height for approximately 1 mm-thickness.

As illustrated on FIG. 5, the left-hand side of the supporting wing forms a first bearing surface 11 for a tagging item and exhibits a first wedging rim 13 as well as corresponding tongues 7, in particular two in number, enabling to delineate a first insertion space for the tagging item. So as to arrange the tagging item in this first insertion space, the first wedging rim 13 as well as a first row of toes 81, 82, 83 are oriented substantially along a direction parallel to the longitudinal axis of the supporting wing 5. The toes 81, 82, 83, in particular three in number, protrude from the first bearing surface 11.

As illustrated on FIG. 6, the right-hand side of the supporting wing forms a second bearing surface 12 for a tagging item, exhibiting a second wedging rim 14 as well as associated tongues 7, in particular two in number, enabling to delineate a second insertion space for the tagging item.

So as to arrange the tagging item in this second insertion space, the second wedging rim 14 as well as a second row of toes 84, 85, 86 are oriented substantially parallel to one another along a tilted direction relative to the longitudinal axis of the supporting wing, in particular 30°.

The toes, in particular three in number protrude respectively from said second bearing surface 12 and from the tongues 7. It will be noted that according to this example, the supporting wing 5 may exhibit openings 15 facing said tongues 7, in particular provided in the case of an injection-moulding manufacture. The device may in particular consist of a single-piece plastic element.

The invention also relates to a method for making a device for the display of a tagging item, as described previously, of plastic material, a method wherein the device is injection-moulded.

Naturally, other embodiments, understandable to the man of the art, could have been contemplated without departing from the framework of the invention defined by the claims below.

1. A device for display of a tagging item, such as in particular an advertising leaflet or the like, on a shelf of a selling surface, said device exhibiting said tagging item vertically, said tagging item protruding notably externally and at right angle from the front of the shelf, said device comprising:
a supporting wing having a lower end being comprised of a means for assembly on a proximal section of the shelf and a means for holding the tagging item by one of the tagging item, the holding means exhibiting the tagging item according to two different orientations relative to the supporting wing, said supporting wing having two bearing surfaces for said tagging item.

2. A device according to claim 1, wherein the holding means of the tagging item comprises a set of tongues and a set of toes, said tongues extending parallel to a plane of said supporting wing to define two spaces, run through by said toes, in order to insert said tagging item, said toes engaging into corresponding orifices of the tagging item, wherein said bearing surfaces are equipped respectively with said tongues enabling to delineate both said insertion spaces.

3. A device according to claim 2, wherein said two bearing surfaces or said insertion spaces or both are equipped respectively with a first row of toes and a second row of toes, said second row of toes being tilted relative to said first row.

4. A device according to claim 1, wherein the holding means of the tagging item are comprised of wedging rims co-operating with a ridge of a tagging item, the bearing surfaces being respectively comprised of a first wedging rim and a second wedging rim, said second rim being tilted relative to said first.

5. A device according to the claim 2, wherein said tongues extend from said wedging rims.

6. A device according to claim 2, wherein the toes protrude inside said insertion spaces from said bearing surfaces or from the tongues (7).

7. A device according to claim 2, wherein the supporting wing has openings facing said tongues.

8. A device according to claim 1, wherein both different orientations form a 30°-angle relative to one another.

9. A device according to claim 1, being formed by a single-piece plastic element.

10. A method for making a device for the display of a tagging item according to claim 1 of plastic material, a method wherein said device is injection-moulded.
